(19) United States
(12) Patent Application Publication
(10) Pub. No.: US 2015/0152310 A1
(43) Pub. Date: Jun. 4, 2015

(54) POLYESTER COMPOSITIONS

(71) Applicant: LANXESS Deutschland GmbH, Cologne (DE)

(72) Inventors: Timo IMMEL, Dormagen (DE); Jochen ENDTNER, Cologne (DE); Matthias BIENMUELLER, Krefeld (DE); Tobias BENIGHAUS, Muenster (DE); Ulrich PLUTOWSKI, Dormagen (DE)

(21) Appl. No.: 14/549,114

(22) Filed: Nov. 20, 2014

(30) Foreign Application Priority Data
Dec. 2, 2013 (EP) 13195325.9

(51) Int. Cl. C09K 5/14

(52) U.S. Cl. CPC C09K 5/14

(57) ABSTRACT

The present invention relates to compositions, especially thermoplastic moulding compositions, based on polyesters and triclinic pinacoidal aluminium silicate, to the production thereof, and to the use of these compositions as moulding compositions for injection moulding or in extrusion for production of electrically insulating, thermally conductive products, preferably for production of heat sinks, especially of heat sinks for light-emitting diodes (LEDs).

The present invention relates to compositions, especially thermoplastic moulding compositions, based on polyesters and triclinic pinacoidal aluminium silicate, to the production thereof, and to the use of these compositions as moulding compositions for injection moulding or in extrusion for production of electrically insulating, thermally conductive products, preferably for production of heat sinks, especially of heat sinks for light-emitting diodes (LEDs).

### PRIOR ART

Thermoplastic polymers are used for numerous applications in the electrical industry because of their good electrical insulation properties. However, because of their low thermal conductivity, they also act as thermal insulators, which constitutes a problem in use for electrical components when a relatively large amount of heat arises and has to be removed. For example, in the case of LEDs, only a proportion in the range from about 20% to 30% of the electrical energy absorbed is converted to light; the remainder is obtained as heat loss. Compared to lighting with conventional lamps, the dissipation of this lost heat is very much more difficult. On the one hand, the temperature of the LEDs has to be kept at a very low level because the efficiency and lifetime are otherwise impaired. On the other hand, LEDs also enable a particularly small design and emit almost no heat, and so the heat has to be removed at first by thermal conduction in particular.

Nowadays, metallic heat sinks, usually made from aluminium or copper, are typically used to cool LEDs. One disadvantage of these heat sinks is the high specific density of the metallic materials and the inevitably high component weight because of the metal. An additional disadvantage is the electrical conductivity of the metal and the associated short-circuit risk. One possible solution in this respect is electrically insulating heat sinks made from heat-conducting plastics.

The use of heat-conducting plastics as heat sinks for cooling electronic components (DE 10 2007 057 533 A1) and especially also the use thereof in the cooling of LEDs (DE 10 2011 077 668 A1 and US2012/0307501 A1) is known.

Polymers only have low thermal conductivity by nature. In order to achieve a thermal conductivity needed, for example, for use in LED heat sinks, heat-conducting additives are added to the polymer-based moulding compositions for use for the production of heat sinks.

JP 2007 016093 A describes a composition composed of thermoplastic polymers and 1-50% by weight of graphite having improved thermal conductivity of 1.6 W/mK.

Particularly for use in LED heat sinks, US 2012/0319031 A1 describes the use of thermoplastic moulding compositions having 10% to 70% by weight of graphite.

However, the use of graphite in the thermoplastic polymers distinctly impairs the electrically insulating nature of the resulting plastic. In order to get round this disadvantage, in US 2012/0319031 A1, inorganic additives are again added to improve thermal conductivity.

DE 102 60 098 A1 and WO 08/043682 A1 show that thermoplastic polyesters are electrically insulating and thermally conductive as a result of addition of alumina. Further additives listed are low molecular weight and polymeric organic compounds.

However, the use of alumina in the processing of polyester compounds leads to increased wear on the instruments used because of the hardness of alumina. In the case of extrusion of alumina-based moulding compositions, particularly the screw, screw housing and die are affected by increased wear. In the case of processing in an injection moulding operation, wear on the injection mould is additionally distinctly increased.

A solution to the problem of increased wear caused by alumina on instruments to be used is demonstrated by EP 2 078 736 A1. This describes the use of thermoplastic moulding compositions, preferably based on polyesters, with boron nitride as thermally conductive additive. However, the thermal conductivity of boron nitride is direction-dependent because of the anisotropy of boron nitride. High thermal conductivities of more than 2 W/mK are typically achieved only in the direction of injection. Furthermore, the anisotropy of boron nitride makes the simulation of the thermal conductivity in the component far more difficult, since the alignment of the filler particles in the cooled moulding composition has to be included in the simulation.

U.S. Pat. No. 4,133,797 describes the use of feldspar-containing, anhydrous aluminium silicate in thermoplastic moulding compositions based on a mixture of elastomeric polymers and a polyolefin to achieve, inter alia, an improved/high heat distortion resistance.

German patent specification No. 596365 relates to a process for producing refractory but thermally conductive products, wherein the refractory molten material consists of aluminium silicate.

DE 10 2011 077 668 A1 describes luminaires based on a thermal coupling element made from thermally conductive plastic, using alumina, aluminium, copper, boron nitride or carbon in the form of graphite or nanotubes as a thermally conductive filler.

The problem addressed by the present invention was that of providing thermoplastic moulding compositions based on polyesters for production of electrically insulating, thermally conductive products, preferably of heat sinks, especially of heat sinks for light-emitting diodes (LEDs). These are to have high isotropic heat conduction and, in particular, a high thermal conductivity, even orthogonally to the direction of injection, combined with simultaneously good mechanical properties. Furthermore, the abovementioned disadvantages associated with the use of alumina or graphite are to be avoided.

It has been found that, surprisingly, thermoplastic moulding compositions based on polyesters comprising aluminium silicate having triclinic pinacoidal crystal structure in the form of the mineral kyanite are outstandingly suitable by virtue of their high thermal conductivity, even orthogonally to the direction of injection, and by virtue of good mechanical properties, for production of electrically insulating, thermally conductive products, preferably of heat sinks, especially of heat sinks for light-emitting diodes (LEDs).

### SUMMARY OF THE INVENTION

The solution to the problem and hence the subject-matter of the invention is therefore compositions comprising
a) 15% to 70% by weight of at least one polyester,

b) 29% to 84% by weight of aluminium silicate and optionally
c) 0.01% to 15% by weight of talc, where the sum total of all the percentages by weight is always 100.

The present invention preferably provides compositions, especially thermoplastic moulding compositions, comprising
a) 15% to 70% by weight, preferably 15% to 50% by weight, more preferably 20% to 40% by weight of at least one polyester, preferably PBT, PET or PCT or blends of any desired combinations thereof, more preferably blends of PBT and PET in which the proportion of PET based on the sum total of all the polyesters present is in the range from 50% to 99.9% by weight, and
b) 30% to 85% by weight of triclinic pinacoidal aluminium silicate, preferably 45% to 80% by weight of triclinic pinacoidal aluminium silicate, more preferably 55% to 75% by weight of triclinic pinacoidal aluminium silicate, where the sum total of all the percentages by weight is 100.

For clarity, it should be noted that the scope of the present invention encompasses all the definitions and parameters mentioned hereinafter in general terms or specified within areas of preference, in any desired combinations. Unless stated otherwise, all figures are based on room temperature (RT)=23 +/−2° C. and on standard pressure, 1 bar.

In addition, for clarity, it should be noted that the compositions, in a preferred embodiment, may be mixtures of components a) and b), and also thermoplastic moulding compositions that can be produced from these mixtures by means of reprocessing operations, preferably by means of at least one mixing or kneading apparatus, but also products that can be produced from these in turn, especially by extrusion or injection moulding.

The preparation of the compositions according to the present invention for their further application or use takes place by mixing components a) and b) or components a), b) and c) as educts in at least one mixing tool. Mouldings are obtained as intermediate products and based on the compositions according to the present invention. These mouldings can exist either exclusively of the components a) and b) or of the components a), b) and c), or include, however, in addition to components a) and b) or in addition to components a), b) and c) even other components. In this case the components a) and b) or the components a), b) and c) are to be varied within the scope of the given amount areas in such way that the sum of all weight percent always result in 100.

In the case of thermoplastic moulding compositions and products that can be produced therefrom, the proportion of the inventive compositions therein is preferably in the range from 50% to 100% by weight, the other constituents being additives selected by the person skilled in the art in accordance with the later use of the products, preferably from at least one of components c) to h) defined hereinafter. The invention thus preferably firstly provides compositions, especially thermoplastic moulding compositions, comprising
a) 15% to 70% by weight, preferably 15% to 50% by weight, more preferably 20% to 40% by weight of at least one polyester, preferably PBT, PET or PCT or blends of any desired combinations thereof, more preferably blends of PBT and PET in which the proportion of PET based on the sum total of all the polyesters present is in the range from 50% to 99.9% by weight, and
b) 30% to 85% by weight of triclinic pinacoidal aluminium silicate, preferably 45% to 80% by weight of triclinic pinacoidal aluminium silicate, more preferably 55% to 75% by weight of triclinic pinacoidal aluminium silicate, where the amounts of components a) and b) should be combined in such a way that the sum total of all the percentages by weight is 100, and these compositions may comprise further additives as per components c) to h).

The invention preferably secondly provides compositions, especially thermoplastic moulding compositions, comprising
a) 15% to 70% by weight, preferably 15% to 50% by weight, more preferably 20% to 40% by weight of at least one polyester, preferably PBT, PET or PCT or blends of any desired combinations thereof, more preferably blends of PBT and PET in which the proportion of PET based on the sum total of all the polyesters present is in the range from 50% to 99.9% by weight,
b) 29% to 84% by weight of triclinic pinacoidal aluminium silicate, preferably 45% to 80% by weight of triclinic pinacoidal aluminium silicate, more preferably 55% to 75% by weight of triclinic pinacoidal aluminium silicate, and
c) 1% to 15% by weight, preferably 0.01% to 10% by weight, more preferably 0.01% to 5% by weight, of talc, preferably microcrystalline talc, in which case the amount of at least one of components a) and b) should be reduced in such a way that the sum total of all the percentages by weight is 100, and these compositions too may comprise further additives of components d) to h).

Good mechanical properties of products that can be produced in turn from the inventive compositions or the thermoplastic moulding compositions that can be produced therefrom feature high values for Izod impact resistance and simultaneously high values or at least maintenance of the properties in relation to edge fibre elongation with respect to the prior art.

Impact resistance describes the ability of a material to absorb impact energy and shock energy without fracturing. The testing of Izod impact resistance to ISO 180 is a standard method for determining impact resistance of materials. This involves first holding an arm at a particular height (=constant potential energy) and finally releasing it. The arm hits the sample, fracturing it. The impact energy is determined from the energy which is absorbed by the sample. Impact resistance is calculated as the ratio of impact energy and specimen cross section (unit of measurement: kJ/m²). Impact resistance was determined in the context of the present invention in analogy to ISO 180-1U at 23° C.

Edge fibre elongation is determined in the context of the present invention in a short-term bending test in analogy to ISO 178. For this purpose, bar-shaped specimens, preferably having the dimensions 80 mm·10 mm·4 mm, are placed with their ends on two supports and loaded with a flexing ram in the middle. The forces and deflections found are used to calculate the characteristic values of edge fibre elongation (Bodo Carlowitz: Tabellarische Übersicht über die Prüfung von Kunststoffen [Tabular Overview of the Testing of Plastics], 6th edition, Giesel-Verlag für Publizität, 1992, p. 16-17).

### PREFERRED EMBODIMENTS OF THE INVENTION

In a preferred embodiment, the inventive compositions comprise, in addition to components a) and b) and optionally c), also
d) 0.01% to 5% by weight, preferably 0.05% to 4% by weight, more preferably 0.1% to 3% by weight, of at least one phosphite stabilizer, in which case the amount of at least one of components a), b) and optionally c) should be reduced such that the sum total of all the percentages by weight is 100.

In a preferred embodiment, the inventive compositions comprise, in addition to components a), b) and optionally c) and/or d), or instead of c) and/or d), also
e) 0.01 % to 10% by weight of at least one additive for improving flowability, also referred to as flow auxiliary, flow agent, flow aid or internal lubricant, in which case the amount of at least one of the other components should be reduced to such an extent that the sum total of all the percentages by weight is 100.

In a preferred embodiment, the inventive compositions comprise, in addition to components a), b) and optionally c) and/or d) and/or e), or instead of c) and/or d) and/or e), also
f) 0.01% to 5% by weight, preferably 0.1% to 2% by weight, more preferably 0.5% to 1% by weight, of at least one form of carbon black, in which case the amount of at least one of the other components should be reduced to such an extent that the sum total of all the percentages by weight is 100.

In a preferred embodiment, the inventive compositions comprise, in addition to components a), b) and optionally c) and/or d) and/or e) and/or f), or instead of components c) and/or d) and/or e) and/or f), also
g) 0.01% to 15% by weight, preferably 0.01% to 10% by weight, more preferably 0.01% to 5% by weight, of at least one demoulding agent, in which case the amount of at least one of the other components should be reduced to such an extent that the sum total of all the percentages by weight is 100.

In a preferred embodiment, the inventive compositions comprise, in addition to components a), b) and optionally c) and/or d) and/or e) and/or f) and/or g), or instead of components c) and optionally d) and/or e) and/or f) and/or g), also
h) 0.01% to 45% by weight, preferably 0.01% to 30% by weight, more preferably 0.01% to 15% by weight, of at least one other additive other than components c) and/or d) and/or e) and/or f) and/or g), in which case the amounts of at least one of the other components should be reduced to such an extent that the sum total of all the percentages by weight is 100.

### Component a)

According to the invention, at least one polyester is used as component a), preferably at least one polyalkylene terephthalate or polycycloalkylene terephthalate, more preferably at least one polyester from the group of polybutylene terephthalate (PBT), polyethylene terephthalate (PET), poly(1,4-cyclohexanedimethanol terephthalate) (PCT), or a blend based on PBT and PET, or a blend based on PBT and PCT, or a blend based on PET and PCT, or a blend based on PBT, PET and PCT. Very particularly preferred blends are those of PBT and PET in which the proportion of PET based on the sum total of all the polyesters present is in the range from 50% to 99.9% by weight.

The polyesters for use in accordance with the invention are reaction products of aromatic dicarboxylic acids or the reactive derivatives thereof, preferably dimethyl esters or anhydrides, and aliphatic, cycloaliphatic or araliphatic diols and mixtures of these reactants. They can be prepared from terephthalic acid (or the reactive derivatives thereof) and the particular aliphatic diols having 2 or 4 carbon atoms or the cycloaliphatic 1,4-bis(hydroxymethyl)cyclohexane by known methods (Kunststoff-Handbuch [Plastics Handbook], vol. VIII, p. 695 ff, Karl-Hanser-Verlag, Munich 1973).

PET for use with preference as polyester contains at least 80 mol %, preferably at least 90 mol %, based on the dicarboxylic acid, of terephthalic acid residues and at least 80 mol %, preferably at least 90 mol %, based on the diol component, of ethylene glycol residues.

PBT for use with preference as polyester contains at least 80 mol %, preferably at least 90 mol %, based on the dicarboxylic acid, of terephthalic acid residues and at least 80 mol %, preferably at least 90 mol %, based on the diol component, of butane-1,4-diol glycol residues.

PCT for use with preference as polyester contains at least 80 mol %, preferably at least 90 mol %, based on the dicarboxylic acid, of terephthalic acid residues and at least 80 mol %, preferably at least 90 mol %, based on the diol component, of 1,4-bis(hydroxymethyl)cyclohexane glycol residues.

The abovementioned polyesters for use with preference may contain, as well as terephthalic acid residues, up to 20 mol% of residues of other aromatic dicarboxylic acids having 8 lo 14 carbon atoms or residues of aliphatic dicarboxylic acids having 4 to 12 carbon atoms, preferably residues of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid or cyclohexanedicarboxylic acid.

The abovementioned polyesters for use with preference may contain, as well as ethylene glycol residues, butane-1,4-diol glycol residues or 1,4-bis(hydroxymethyl)cyclohexane glycol residues, up to 20 mol % of other residues of aliphatic diols having 3 to 12 carbon atoms or cycloaliphatic diols having 6 to 21 carbon atoms. Preference is given to residues of propane-1,3-diol, 2-ethylpropane-1,3-diol, neopentyl glycol, pentane-1,5-diol, hexane-1,6-diol, 3-methylpentane-2,4-diol, 2-methylpentane-2,4-diol, 2,2,4-trimethylpentane-1,3-diol, 2,2,4-trimethylpentane-1,6-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxphenyl)propane or 2,2-bis(4-hydroxypropoxyphenyl)propane (DE-A 24 07 674 (=U.S. Pat. No. 4,035,958), DE-A 24 07 776, DE-A 27 15 932 (=U.S. Pat. No. 4,176,224)).

In one embodiment, the abovementioned polyesters for use with preference may be branched through incorporation of relatively small amounts of tri- or tetrahydric alcohols or tri- or tetrabasic carboxylic acids, as described, for example, in DE-A 19 00 270 (=U.S. Pat. No. 3,692,744). Preferred branching agents are trimesic acid, trimellitic acid, trimethylolethane and trimethylolpropane, and pentaerythritol.

The abovementioned polyesters for use with preference in accordance with the invention preferably have an intrinsic viscosity in the range from about 30 cm3/g to 150 cm3/g, more preferably in the range from 40 cm3/g to 130 cm3/g, especially preferably in the range from 50 cm3/g to 100 cm3/g, in each case measured in phenol/o-dichlorobenzene (1:1 parts by weight) at 25° C. by means of an Ubbelohde viscometer. Intrinsic viscosity [η] is also called the limiting viscosity number or Staudinger index, since it is firstly a material constant and secondly is related to the molecular weight. It indicates how the viscosity of the solvent is affected by the dissolved substance. Intrinsic viscosity is determined using the following definition:

$$[ n ] = {lim}_{c \to 0} \frac{{η}_{sp}}{c} = {lim}_{c \to 0} \frac{1}{c} ln ( \frac{η}{{η}_{0}} )$$

where c is the concentration of the dissolved substance in g/ml, η₀ is the viscosity of the pure solvent and

$${η}_{sp} = \frac{η}{{η}_{0}} - 1$$

is the specific viscosity.

The viscosity is measured by drying the material to be examined to a moisture content of not more than 0.02%, determined by means of the Karl Fischer method known to those skilled in the art, in a commercial air circulation dryer at 120° C. (see: http://de.wikipedia.org/wiki/Karl-Fischer-Verfahren).

PBT for use in accordance with the invention (CAS No. 24968-12-5) can be purchased, for example, from Lanxess Deutschland GmbH, Cologne, Germany, under the Pocan® B1300 name.

PET for use in accordance with the invention (CAS No. 25038-59-9) can be purchased, for example, in the form of PET V004 polyester chips from Invista, Wichita, USA.

PCT for use in accordance with the invention (CAS No. 24936-69-4) can be purchased, for example, from SK Chemicals under the Puratan® trade name. The polyesters for use as component a) may optionally also be used in a mixture with other polyesters and/or further polymers.

### Component b)

Triclinic pinacoidal aluminium silicate (Al₂SiO₅) which is used as component b) is also known by the kyanite name (CAS No. 1302-36-7). Kyanite refers to an aluminium silicate having a specific crystal form, triclinic pinacoidal, and is also given the names cyanite, disthene or sapparite. The 9th edition of the Strunz mineral classification, which has been in force since 2001 and is used by the International Mineralogical Association (IMA) classifies kyanite in the class of “silicates and germanates”, and in the division of the “nesosilicates” therein. This division, however, is further divided according to the possible presence of further anions and the coordination of the cations involved, such that the mineral, in accordance with its composition, is to be found in the sub-division of the “nesosilicates with additional anions; cations in [4], [5] and/or only [6] coordination” where it is the sole member of the unnamed 9.AF.15 group. Preference is given to using triclinic pinacoidal Al₂SiO₅ in the form of powder. Preferred powders having a median particle size d₅₀ of not more than 500 μm, preferably 0.1 to 250 μm, more preferably 0.5 to 150 μm, most preferably 0.5 to 70 μm—the median particle size being determined in analogy to ASTM D 1921-89, Method A—which assures fine distribution in the thermoplastic or in the inventive mixtures and thermoplastic moulding compositions.

The triclinic pinacoidal Al₂SiO₅ particles for use in accordance with the invention may be in different forms which can be described by the aspect ratio. Preference is given to using particles having a aspect ratio of 1 to 100, more preferably 1 to 30, most preferably 1 to 10, which can be determined, for example, by a process according to EP 0 528 078 A1.

The Al₂SiO₅ particles having triclinic pinacoidal crystal structure for use in accordance with the invention can be used with or without surface modification. Surface modification refers to the organic coupling agents which are intended to improve binding to the thermoplastic matrix. Surface modification is preferably accomplished using aminosilianes, epoxysilanes, methacryloylsilanes, trimethylsilanes, methylsilanes or vinylsilanes, more preferably using epoxysilanes or methacryloylsilanes. In a preferred embodiment, the triclinic pinacoidal Al₂SiO₅ particles, or kyanite particles, for use in accordance with the invention are used without surface modification. One example of a kyanite supplier is Quarzwerke GmbH, Frechen, Germany, which supplies kyanite as Al₂SiO₅ as Silatherm®.

### Component c)

Talc is used as component c), preferably microcrystalline talc. Talc (CAS No. 14807-96-6) is a sheet silicate having the chemical composition Mg₃[Si₄O₁₀(OH)₂], which, according to the polymorph, crystallizes as talc-1A in the triclinic crystal system or as talc-2M in the monoclinic crystal system (http://de.wikipedia.org/wiki/Talkum).

Microcrystalline talc in the context of the present invention is described in WO 2014/001158 A1, the content of which are fully encompassed by the present application. In one embodiment of the present invention, microcrystalline talc having a median particle size d₅₀ determined using a SediGraph in the range from 0.5 to 10 μm is used, preferably in the range from 1.0 to 7.5 μm, more preferably in the range from 1.5 to 5.0 μm and most preferably in the range from 1.8 to 4.5 μm.

As described in WO 2014/001158 A1, in the context of the present invention, the particle size distribution of the talc for use in accordance with the invention is determined by sedimentation in a fully dispersed state in an aqueous medium with the aid of a “Sedigraph 5100” as supplied by Micrometrics Instruments Corporation, Norcross, Ga., USA. The Sedigraph 5100 delivers measurements and a plot of cumulative percentage by weight of particles having a size referred to in the prior art as “equivalent sphere diameter” (esd), minus the given esd values. The median particle size d50 is the value determined from the particle esd at which 50% by weight of the particles have an equivalent sphere diameter smaller than this d50 value. The underlying standard is ISO 13317-3.

In one embodiment, microcrystalline talc is defined via the BET surface area. Microcrystalline talc for use in accordance with the invention preferably has a BET surface area, which can be determined in analogy to DIN ISO 9277, in the range from 5 to 25 m²·g⁻¹, more preferably in the range from 10 to 18 m²·⁻¹, most preferably in the range from 12 to 15 m²*g⁻¹.

Talc for use in accordance with the invention can be purchased, for example, as Mistron® R10 from Imerys Talc Group, Toulouse, France (Rio Tinto Group).

### Component d)

As component d), preferably at least one phosphite stabilizer which is selected from the group of tris(2,4-di-tert-butylphenyl) phosphite (Irgafos® 168, BASF SE, CAS No. 31570-04-4), bis(2,4-di-tert-butylphenyl)pentaerythrityl diphosphite (Ultranox® 626, Chemtura, CAS No. 26741-53-7), bis(2,6-di-tert-butyl-4-methylphenyl)pentaerythrityl diphosphite (ADK Stab PEP-36, Adeka, CAS No. 80693-00-1), bis(2,4-dicumylphenyl)pentaerythrityl diphosphite (Doverphos® S-9228, Dover Chemical Corporation, CAS No. 154862-43-8), tris(nonylphenyl) phosphite (Irgafos® TNPP, BASF SE, CAS No. 26523-78-4), (2,4,6-tri-t-butylphenol)-2-butyl-2-ethyl-1,3-propanediol phosphite (Ultranox® 641, Chemtura, CAS No. 161717-32-4) and tetrakis(2,4-di-tert-butylphenyl)-1,1-biphenyl-4,4′-diyl bisphosphonite (main constituent of Hostanox® P-EPQ) is used.

The phosphite stabilizer used is especially preferably at least Hostanox® P-EPQ (CAS No. 119345-01-6) from Clariant International Ltd., Muttenz, Switzerland. This comprises tetrakis(2,4-di-tert-butylphenyl)-1,1-biphenyl-4,4′-diyl bisphosphonite (CAS No. 38613-77-3), which can especially be used with very particular preference as component d) in accordance with the invention.

### Component e)

The additive for use in accordance with the invention as component e) for improving flowability is also referred to as flow auxiliary, flow agent, flow aid or internal lubricant. Flow auxiliaries of this kind are known from the literature, for example in Kunststoffe 2000, 90 (9), p. 116-118, and may preferably be fatty acid esters of polyols or amides formed from fatty acids and amines. As an alternative to the surface-active flow auxiliaries, it is possible to use internal flow auxiliaries compatible with the polymer resins. Preferentially suitable for this purpose are low molecular weight compounds or branched, highly branched or dendritic polymers having a polarity similar to the polymer resin. Highly branched or dendritic systems of this kind are known from the literature and may preferably be based on branched polyesters, polyamides, polyester amides, polyethers or polyamines, as described in Kunststoffe 2001, 91 (10), p. 179-190, or in Advances in Polymer Science 1999, 143 (Branched Polymers II), p. 1-34. Particular preference is given to using copolymers of α-olefins with methacrylic esters or acrylic esters of aliphatic alcohols. They can be purchased, for example, from Atofina Deutschland, Düsseldorf under the Lotryl® trade name.

Flow auxiliaries for use with preference as component e) are copolymers of at least one α-olefin with at least one methacrylic ester or acrylic ester of an aliphatic alcohol, preferably an aliphatic alcohol having 1-30 carbon atoms, with an MFI (melt flow index) of the copolymer of not less than 100 g/10 min, preferably 150 g/10 min, the MFI (melt flow index) having been measured or determined uniformly in the context of the present invention in analogy to ISO 1133 at 190° C. and a test weight of 2.16 kg. In a preferred embodiment, the copolymer does not contain any further reactive functional groups.

The melt flow index (MFI, or MFR=melt flow rate) serves to characterize the flow characteristics (moulding composition testing) of a thermoplastic material under particular pressure and temperature conditions. It is a measure of the viscosity of the polymer melt. From this, it is possible to conclude the degree of polymerization, i.e. the mean number of monomer units in a molecule. The MFI indicates the mass of polymer melt which is forced through a die by a barrel within a particular time under standard conditions. The unit of MFI is g/10 min. If a polymer—for example through chemical attack or radiation—is damaged such that chain breakdown sets in, there will be a decrease in its melt viscosity and a rise in the melt volume flow rate. To measure the MFI, an upright metal barrel is heated to constant temperature. The barrel ends at the lower end of the standard die. The polymer material to be tested (about 5 g) is introduced into the barrel. A piston with the material-dependent weight thereon, in the present case 2.16 kg, forces the melt through the die (see also http://www.schmeizindex.de/). In MFI measurement, the following steps are distinguished:
1. Choose test temperature and test weight (ISO 1133)
2. The melt is introduced into the fully heated barrel and compressed manually.
3. Preheating time without load 240 s and total preheating time 300 s
4. The first strand segment that emerges is discarded.
5. If the melt is free of bubbles, strand sections are removed at constant time intervals, for example every 60 s, depending on the material flow, cooled and then weighed, and converted up to 10 min.
6. Amount of material according to melt flow rate, max. 30 mm (pistons of upper and lower rings)
7. The melt flow index indicates how many grams of a polymer are forced through a capillary of a particular geometry in 10 min, and so the unit is g/10 min.

The following relationship applies: MFI=600 * m/t in which m represents the mean weight of the strand sections and t the time interval in seconds.

α-Olefins preferentially suitable in accordance with the invention as a constituent of the copolymers for use as the flow auxiliary e) have between 2 and 10 carbon atoms and may be unsubstituted or substituted by one or more aliphatic, cycloaliphatic or aromatic groups. Preferred α-olefins are selected from the group comprising ethane, propone, 1-butene, 1-pentene, 1-hexene, 1-octene, 3-methyl-1-pentene. Particularly preferred α-olefins are ethene and propane, very particular preference being given to ethene. Likewise suitable are mixtures of the α-olefins described.

The content of the α-olefin in the copolymer for use as flow auxiliary e) is in the range from 50% to 90% by weight, preferably in the range from 55% to 75% by weight, of the overall copolymer.

The copolymer for use as component e) and flow auxiliary is further defined by the second constituent alongside the α-olefin. Suitable second constituents are alkyl or arylalkyl esters of acrylic acid or methacrylic acid, wherein the alkyl or arylalkyl group is formed from 1-30 carbon atoms and contains only a low concentration, if any, of reactive functions selected from the group comprising epoxides, oxetanes, anhydrides, imides, aziridines, furans, acids, amines. The alkyl or arylalkyl group may be linear or branched and contain cycloaliphatic or aromatic groups, and may additionally also be substituted by one or more ether or thioether functions. Preferentially suitable methacrylic esters or acrylic esters in this context are also those which have been synthesized from an alcohol component based on oligoethylene or oligopropylene glycol having only one hydroxyl group and not more than 30 carbon atoms.

More preferably, the alkyl or arylalkyl group of the methacrylic or acrylic ester is selected from the group comprising 1-pentyl, 1-hexyl, 2-hexyl, 3-hexyl, 1-heptyl, 3-heptyl, 1-octyl, 2-ethylhex-1-yl, 1-nonyl, 1-decyl, 1-dodecyl, 1-lauryl or 1-octadecyl. Very particular preference is given to alkyl or arylalkyl groups having 6-20 carbon atoms. Preference is especially also given to branched alkyl groups that lead to a lower glass transition temperature T_{G} compared to linear alkyl groups having the same number of carbon atoms.

Copolymers for use with especial preference as component e) in accordance with the invention are those in which the α-olefin is copolymerized with 2-ethylhexyl acrylate.

Likewise suitable are mixtures of the acrylic esters or methacrylic esters described.

The content of the acrylic esters or methacrylic esters in the copolymer for use as component e) is preferably in the range from 10% to 50% by weight, more preferably in the range from 25% to 45% by weight, of the overall copolymer.

Features of the copolymers for use with preference as component e) are not just the composition but also the low molecular weight. Accordingly, copolymers especially suitable for component e) are those which have an MFI value measured at 190° C. and a load of 2.16 kg of at least 100 g/10 min, preferably of at least 150 g/10 min. Copolymers for use with especial preference in accordance with the invention are supplied, for example, as Lotryl® 37 EH 175 or Lotryl® 37 EH 550 by Arkema, Puteaux, France.

### Component f)

According to the invention, at least one form of carbon black (CAS No. 1333-86-4) is used as component f). The term “carbon black”, as opposed to soot, is usually used for the industrial raw material produced under controlled conditions, and sometimes also the older term “industrial carbon black”. Industrial carbon black is a polymorph of carbon having a very high surface area and is used particularly as a filler and as a black pigment. The classification of standard carbon blacks by the US ASTM standard is customary internationally. Preference is given to the use of carbon black having a particle size in the range from 5 to 60 nm, more preferably in the range from 10 to 40 nm and most preferably in the range from 15 to 25 nm. The carbon blacks for use in accordance with the invention are preferably used in the form of powder or beads. Carbon blacks for use with very particular preference as component f) are selected from the group of ASTM Standards N220, N234, N294, N330, N326, N347, N440, N472, N539, IM550, N568, N601, N660, N762, N770, N785, N880 and N990 (http://de.wikipedia.org/wiki/Ru%C3%9F), Carbon black for use in accordance with the invention as component f) is also referred to as black pigment (C. I. Pigment Black 7). Further products include Orion Cabot black pigments (PRINTEX, HIBLACK, AROSPERSE, NIPex, NEROX, COLOUR BLACK, SPECIAL BLACK), or, from the manufacturer Biria Carbon, the products Raven, Conductex, Copeblack, or, from the manufacturer Cabot, the products BLACK PEARLS, ELFTEX, MOGUL, MONARCH, REGAL, SPHERON, STERLING, VULCAN, CSX, CRX, IRX, UNITED. Carbon blacks for use as a filler preferably have BET surface areas in the range from 5 to 200 m²/g, determined in analogy to DIN ISO 9277:2003-05.

### Component g)

According to the invention, at least one demoulding agent is used as component g). Preferred demoulding agents used are at least one selected from the group of ester wax(es), pentaerythrityl tetrastearate (PETS), long-chain fatty acids, salt(s) of the long-chain fatty acids, amide derivative(s) of the long-chain fatty acids, montan waxes and low molecular weight polyethylene or polypropylene wax(es), or ethylene homopolymer wax(es).

Preferred long-chain fatty acids are stearic acid or behenic acid. Preferred salts of long-chain fatty acids are calcium stearate or zinc stearate. A preferred amide derivative of long-chain fatty acids is ethylenebisstearylamide (CAS No. 110-30-5). Preferred montan waxes are mixtures of straight-chain saturated carboxylic acids having chain lengths of 28 to 32 carbon atoms.

### Component h)

According to the invention, at least one additive different from components b), c), d), e), f) and g) is used as component h).

Preferred additives for component h) are stabilizers, UV stabilizers, gamma ray stabilizers, antistats, flow auxiliaries, flame retardants, elastomer modifiers, fire-retardant additives, emulsifiers, nucleating agents, acid scavengers, plasticizers, lubricants, dyes or pigments, and optionally additional thermal conductivity additives other than component b). These and further suitable additives are described, for example, in Gāchter, Mũller, Kunststoff-Additive [Plastics Additives], 3rd edition, Hanser-Verlag, Munich, Vienna, 1989 and in the Plastics Additives Handbook, 5th Edition, Hanser-Verlag, Munich, 2001. The additives can be used alone or in a mixture, or in the form of masterbatches.

Stabilizers for use independently of component d) are preferably sterically hindered phenols, hydroquinones, aromatic secondary amines such as diphenylamines, substituted resorcinols, salicylates, benzotriazoles and benzophenones, and also variously substituted representatives of these groups or mixtures thereof.

Pigments or dyes for use independently of component f) are preferably zinc sulphide, titanium dioxide, ultramarine blue, iron oxide, phthalocyanines, quinacridones, perylenes, nigrosine and anthraquinones. Titanium dioxide (CAS No. 13463-67-7), which is used with preference as pigment, preferably has a median particle size in the range from 90 nm to 2000 nm. As described in WO 2014/001158 A1, in the context of the present invention, particle size is also determined by sedimentation in a fully dispersed state in an aqueous medium with the aid of a “Sedigraph 5100” as supplied by Micrometrics Instruments Corporation, Norcross, Ga., USA. The Sedigraph 5100 delivers measurements and a plot of cumulative percentage by weight of particles having a size referred to in the prior art as “equivalent sphere diameter” (esd), minus the given esd values. The median particle size d50 is the value determined from the particle esd at which 50% by weight of the particles have an equivalent sphere diameter smaller than this d50 value. The underlying standard is ISO 13317-3.

Useful titanium dioxide pigments for the titanium dioxide for use with preference as pigment in accordance with the invention include those whose base structures can be produced by the sulphate (SP) or chloride (CP) method, and which have anatase (CAS No. 1317-70-0) and/or rutile structure (CAS No. 1317-80-2), preferably rutile structure. The base structure need not be stabilized, but preference is given to a specific stabilization; in the case of the CP base structure by an Al doping of 0.3-3.0% by weight (calculated as Al₂O₃) and an oxygen excess in the gas phase in the oxidation of the titanium tetrachloride to titanium dioxide or at least 2%; in the case of the SP base structure by a doping, for example, with Al, Sb, Nb or Zn. More preferably, in order to obtain a sufficiently high brightness of the products to be produced from the inventive compositions, a “light” stabilization with Al is preferred, or compensation with antimony in the case of higher amounts of Al dopant. In the case of use of titanium dioxide as white pigment in paints and coatings, plastics etc., it is known that unwanted photocatalytic reactions caused by UV absorption lead to breakdown of the pigmented material. This involves absorption of light in the near ultraviolet range by titanium dioxide pigments, forming electron-hole pairs, which produce highly reactive free radicals on the titanium dioxide surface. The free radicals formed result in binder degradation in organic media. Preference is given in accordance with the invention to lowering the photoactivity of the titanium dioxide by inorganic aftertreatment thereof, more preferably with oxides of Si and/or Al and/or Zr and/or through the use of Sn compounds.

Preferably, the surface of pigmentary titanium dioxide is covered with amorphous precipitated oxide hydrates of the compounds SiO₂ and/or Al₂O₃ and/or zirconium oxide. The Al₂O₃ shell facilitates pigment dispersion in the polymer matrix; the SiO₂ shell makes it difficult for charges to be exchanged at the pigment surface and hence prevents polymer degradation.

According to the invention, the titanium dioxide is preferably provided with hydrophilic and/or hydrophobic organic coatings, especially with siloxanes or polyalcohols. Commercially available titanium dioxide products are, for example, Kronos® 2230, Kronos® 2225 and Kronos® vlp7000 from Kronos, Dallas, USA.

Nucleating agents used, in addition to the talc described under c), are preferably sodium phenylphosphinate or calcium phenylphosphinate, alumina or silicon dioxide.

Acid scavengers used are preferably hydrotalcite, chalk, boehmite or zinc stannate.

Plasticizers used are preferably dioctyl phthalate, dibenzyl phthalate, butyl benzyl phthalate, hydrocarbon oils or N-(n-butyl)benzenesulphonamide.

Additives used as elastomer modifier are preferably one or more graft polymer(s) E of
E.1 5% to 95% by weight, preferably 30% to 90% by weight, of at least one vinyl monomer onto
E.2 95% to 5% by weight, preferably 70% to 10% by weight, of one or more graft bases having glass transition temperatures of <10° C., preferably <0° C., more preferably <−20 C.

The graft base E.2 generally has a median particle size (d₅₀) of 0.05 to 10 μm, preferably 0.1 to 5 μm, more preferably 0.2 to 1 μm.

Monomers E.1 are preferably mixtures of
E.1.1 50% to 99% by weight of vinylaromatics and/or ring-substituted vinylaromatics (for example styrene, α-methylstyrene, p-methylstyrene, p-chlorostyrene) and/or (C₁-C₈)-alkyl methacrylates (for example methyl methacrylate, ethyl methacrylate and
E.I.2 1% to 50% by weight of vinyl cyanides (unsaturated nitriles such as acrylonitrile and methacrylonitrile) and/or (₁-C₈)-alkyl (meth)acrylates (for example methyl methacrylate, n-butyl acrylate, t-butyl acrylate) and/or derivatives (such as anhydrides and imides) of unsaturated carboxylic acids (for example maleic anhydride and N-phenylmaleimide).

Preferred monomers E.1.1 are selected from at least one of the monomers styrene, glycidyl methacrylate, α-methylstyrene and methyl methacrylate; preferred monomers E.1.2 are selected from at least one of the monomers acrylonitrile, maleic anhydride and methyl methacrylate.

Particularly preferred monomers are E.1,1 styrene and E.1.2 acrylonitrile.

Graft bases E.2 suitable for the graft polymers for use in the elastomer modifiers are, for example, diene rubbers, EP(D)M rubbers, i.e. those based on ethylene/propylene, and optionally diene, acrylate, polyurethane, silicone, chloroprene and ethylene/vinyl acetate rubbers.

Preferred graft bases E.2 are diene rubbers (for example based on butadiene, isoprene etc.) or mixtures of diene rubbers or copolymers of diene rubbers or mixtures thereof with further copolymerizable monomers (for example as per E.1.1 and E.1.2), with the proviso that the glass transition temperature of component E.2 is below <10° C., preferably <0° C., more preferably <−10° C.

A particularly preferred graft base E.2 is pure polybutadiene rubber.

Particularly preferred polymers E are ABS polymers (emulsion, bulk and suspension ABS), as described, for example, in DE-A 2 035 390 (=U.S. Pat. No. 3,644,574) or in DE-A 2 248 242 (=GB-A 1 409 275) or in Ullmann, Enzyklopädie der Technischen Chemie [Encyclopedia of Industrial Chemistry], vol. 19 (1980), p. 280 ff. The gel content of the graft base E.2 is at least 30% by weight, preferably at least 40% by weight (measured in toluene). ABS means acrylonitrile-butadiene-styrene copolymer with CAS number 9003-56-9 and is a synthetic terpolymer formed from the three different monomer types acrylonitrile, 1,3-butadiene and styrene. It is one of the amorphous thermoplastics. The ratios may vary from 15-35% acrylonitrile, 5-30% butadiene and 40-60% styrene.

The elastomer modifiers or graft copolymers E are prepared by free-radical polymerization, for example by emulsion, suspension, solution or bulk polymerization, preferably by emulsion or bulk polymerization.

Particularly suitable graft rubbers are also ABS polymers, which are prepared by redox initiation with an initiator system composed of organic hydroperoxide and ascorbic acid according to U.S. Pat. No. 4,937,285.

Since, as is well known, the graft monomers are not necessarily grafted completely onto the graft base into the grafting reaction, according to the invention, graft polymers E are also understood to mean those products which are obtained through (co)polymerization of the graft monomers in the presence of the graft base and occur in the workup as well.

Suitable acrylate rubbers are based on graft bases E.2, which are preferably polymers of alkyl acrylates, optionally with up to 40% by weight, based on E.2, of other polymerizable, ethylenically unsaturated monomers. The preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, especially preferably chloroethyl acrylate, and mixtures of these monomers.

For crosslinking, it is possible to copolymerize monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms, or of saturated polyols having 2 to 4 OH groups and 2 to 20 carbon atoms, for example ethylene glycol dimethacrylate, allyl methacrylate; polyunsaturated heterocyclic compounds, for example trivinyl cyanurate and triallyl cyanurate; polyfunctional vinyl compounds, such as di- and trivinylbenzenes, but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinking monomers is preferably 0.02% to 5%, especially 0.05% to 2%, by weight, based on the graft base E.2.

In the case of cyclic crosslinking monomers having at least 3 ethylenically unsaturated groups, it is advantageous to restrict the amount to below 1% by weight of the graft base E.2.

Preferred “other” polymerizable, ethylenically unsaturated monomers which, alongside the acrylic esters, may optionally serve for preparation of the graft base E.2 are, for example, acrylonitrile, styrene, α-methylstyrene, acrylamide, vinyl C₁-C₆ alkyl ethers, methyl methacrylate, butadiene. Preferred acrylate rubbers as graft base E.2 are emulsion polymers having a gel content of at least 60% by weight.

Further suitable graft bases according to E.2 are silicone rubbers having graft-active sites, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Irrespective of components b) and c), additional fillers and/or reinforcers may be present as additives in the inventive compositions.

Preference is also given to using a mixture of two or more different fillers and/or reinforcers, especially based on mica, silicate, quartz, titanium dioxide—if not already used as pigment, wollastonite, kaolin, amorphous silicas, magnesium carbonate, chalk, feldspar, barium sulphate, glass fibres, glass beads and/or fibrous fillers and/or reinforcers based on carbon fibres. Preference is given to using mineral particulate fillers based on mica, silicate, quartz, wollastonite, kaolin, amorphous silicas, magnesium carbonate, chalk, feldspar or barium sulphate. Particular preference is additionally also given to using acicular mineral fillers as an additive. Acicular mineral fillers are understood in accordance with the invention to mean a mineral filler with a highly pronounced acicular character. The mineral preferably has a length:diameter ratio of 2:1 to 35:1, more preferably of 3:1 to 19:1, most preferably of 4:1 to 12:1. The median particle size d50 of the acicular minerals for use in accordance with the invention is preferably less than 20 μm, more preferably less than 15 μm, especially preferably less than 10 μm, determined with a CILAS GRANULOMETER in analogy to ISO 13320:2009 by means of laser diffraction.

As already described above for component b), in a preferred use form, the filler and/or reinforcer for use as component h) may also have been surface-modified, more preferably with an adhesion promoter or adhesion promoter system, especially preferably based on epoxide. However, the pretreatment is not absolutely necessary.

In a particularly preferred embodiment, glass fibres are used as component h) or as additive. According to “http://de.wikipedia.org/wiki/Faser-Kunststoff-Verbund”, cut fibres, also referred to as short fibres, having a length in the range from 0.1 to 1 mm, are distinguished from long fibres having a length in the range from 1 to 50 mm and continuous fibres having a length L <50 mm. Short fibres are used in injection moulding technology and can be processed directly with an extruder. Long fibres can likewise still be processed in extruders. They are used on a large scale in fibre injection moulding. Long fibres are frequently added to thermosets as a filler. Continuous fibres are used in the form of rovings or fabric in fibre-reinforced plastics. Products comprising continuous fibres achieve the highest stiffness and strength values. Additionally supplied are ground glass fibres having a length after grinding typically in the range from 70 to 200 μm.

According to the invention, chopped long glass fibres having a starting length in the range from 1 to 50 mm, more preferably in the range from 1 to 10 mm, most preferably in the range from 2 to 7 mm, are used as component h). The glass fibres for use as component h) may, as a result of the processing to give the moulding composition or to give the product, have a lower d97 or d50 value in the moulding composition or in the product than the glass fibres originally used. Thus, the arithmetic mean of the glass fibre length after processing is frequently only in the range from 150 μm to 300 μm.

The glass fibre length and glass fibre length distribution are determined in the context of the present invention, in the case of processed glass fibres, in analogy to ISO 22314, which first stipulates ashing of the samples at 625° C. Subsequently, the ash is placed onto a microscope slide covered with demineralized water in a suitable crystallizing dish, and the ash is distributed in an ultrasound bath with no action of mechanical forces. The next step involves drying in an oven at 130° C., followed by the determination of the glass fibre length with the aid of light microscopy images. For this purpose, at least 100 glass fibres are measured in three images, and so a total of 300 glass fibres are used to ascertain the length. The glass fibre length either can be calculated as the arithmetic mean lₙ according to the equation

$${l}_{n} = \frac{1}{n} \cdot \text{?} \text{?}$$

$$\text{?} \text{indicates text missing or illegible when filed}$$

where lᵢ length of the ith fibre and n=number of fibres measured, and be shown in a suitable manner as a histogram, or, in the case that a normal distribution of the glass fibre lengths l measured is assumed, can be determined with the aid of the Gaussian function by equation

$$f ( l ) = \frac{1}{\sqrt{2 π} \cdot σ} \cdot \text{?}$$

$$\text{?} \text{indicates text missing or illegible when filed}$$

Here, l_{c} and σ are specific characteristic values in the normal distribution; l_{c} is the median value and σ the standard deviation (see: M. SchoBig, Schaãdigungsmechanismen in faserverstärkten Kunststoffen [Damage Mechanisms in Fibre-Reinforced Plastics], 1, 2011, Vieweg und Teubner Verlag, page 35, ISBN 978-3-8348-1483-8). Glass fibres not incorporated into a polymer matrix are analysed with respect to their lengths by the above methods, but without processing by ashing and separation from the ash.

The glass fibres for use in accordance with the invention as component h) (CAS No. 65997-17-3) preferably have a fibre diameter in the range from 7 to 18 μm, more preferably in the range from 9 to 15 μm, which can be determined by at least one method available to those skilled in the art, and can especially be determined by μ--x-ray computer tomography in analogy to “Quantitative Messung von Faserlängen and -verteilung in faserverstärkten Kunststoffteilen mittels μ-Röntgen-Computertomographie” [Quantitative Measurement of Fibre Length and Distribution in Fibre-Reinforced Plastics Parts by Means of μ-X-Ray Computer Tomography], J. KASTNER, et al. DGZfP Annual Meeting 2007—Presentation 47. The glass fibres for use as component d) are preferably added in the form of continuous fibres or in the form of chopped or ground glass fibres.

The glass fibres for use as component h) are added in the form of continuous fibres or in the form of chopped or ground glass fibres. The glass fibres for use as component h) are preferably modified with a suitable slip system and an adhesion promoter or adhesion promoter system, more preferably based on silane.

Very particularly preferred silane-based adhesion promoters for the pretreatment are silane compounds of the general formula (I)

(X—(CH₂)_{q})ₖ-Si—(O—CrH₂ᵣ₊₁)₄₋ₖ (I)
in which the substituents are each defined as follows:
X: NH₂—, HO—,

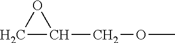

q: an integer from 2 to 10, preferably 3 to 4,
r: an integer from 1 to 5, preferably 1 to 2,
k: an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane, and the corresponding silanes containing a glycidyl group as the X substituent.

For the modification of the glass fibres, the silane compounds are preferably used in amounts in the range from 0.05% to 2% by weight, more preferably in the range from 0.25% to 1,5% by weight and especially in the range from 0.5% to 1% by weight, based on the glass fibres for surface coating.

A useful additional thermal conductivity additive other than component b) is preferably boron nitride or aluminium nitride. Preferably, the ratio of the boron atoms to the nitrogen atoms in the boron nitride, or the ratio of the aluminium atoms to the nitrogen atoms in the aluminium nitride, is greater than 1. More preferably, the ratio of the boron atoms to the nitrogen atoms in the boron nitride is in the range of 1.05-1.2. More preferably, the ratio of the aluminium atoms to the nitrogen atoms in the aluminium nitride is in the range of 1.05-1.25. More preferably, the median particle size (d50) of the boron nitride and aluminium nitride is in the range from 1 μm to 600 μm, determined by means of the Debye-Scherrer method known to those skilled in the art (see: http://de.wikipedia.org/wiki/Debye-Scherrer-Verfahren).

All the particulate fillers for use as component h) may, as a result of the processing to give the moulding composition or shaped body, have a lower d97 or d50 value in the moulding composition or in the shaped body than the fillers originally used.

In a preferred embodiment, the present invention relates to compositions comprising PET, triclinic pinacoidal aluminium silicate and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, tris(nonylphenyl) phosphite, (2,4,6-tri-t-butylphenol)-2-butyl-2-ethyl-1,3-propanediyl phosphite and tetrakis(2,4-di-tert-butylphenyl)-1,1-biphenyl-4,4′-diyl bisphosphonite. In a particularly preferred embodiment, the present invention relates to compositions comprising PET, triclinic pinacoidal aluminium silicate, talc and tetrakis(2,4-di-tert-butylphenyl)-1,1 -biphenyl-4,4′-diyl bisphosphonite.

In a preferred embodiment, the present invention relates to compositions comprising PBT, triclinic pinacoidal aluminium silicate and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, tris(nonylphenyl) phosphite, (2,4,6-tri-t-butylphenol)-2-butyl-2-ethyl-1,3-propanediyl phosphite and tetrakis(2,4-di-tert-butylphenyl)-1,1-biphenyl-4,4′-diyl bisphosphonite. In a particularly preferred embodiment, the present invention relates to compositions comprising PBT, triclinic pinacoidal aluminium silicate, talc and tetrakis(2,4-di-tert-butylphenyl)-1,1 -biphenyl-4,4′-diyl bisphosphonite.

In a preferred embodiment, the present invention relates to compositions comprising PCT, triclinic pinacoidal aluminium silicate and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, tris(nonylphenyl) phosphite, (2,4,6-tri-t-butylphenol)-2-butyl-2-ethyl-1,3-propanediyl phosphite and tetrakis(2,4-di-tert-butylphenyl)-1,1-biphenyl-4,4′-diyl bisphosphonite. In a particularly preferred embodiment, the present invention relates to compositions comprising PCT, triclinic pinacoidal aluminium silicate, talc and tetrakis(2,4-di-tert-butylphenyl)-1,1 -biphenyl-4,4′-diyl bisphosphonite.

In a preferred embodiment, the present invention relates to compositions comprising PET, PBT, triclinic pinacoidal aluminium silicate and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, tris(nonylphenyl) phosphite, (2,4,6-tri-t-butylphenol)-2-butyl-2-ethyl-1,3-propanediyl phosphite and tetrakis(2,4-di-tert-butylphenyl)-1,1-biphenyl-4,4′-diyl bisphosphonite. In a particularly preferred embodiment, the present invention relates to compositions comprising PET, PBT, triclinic pinacoidal aluminium silicate, talc and tetrakis(2,4-di-tert-butylphenyl)-1,1 -biphenyl-4,4′-diyl bisphosphonite.

In a preferred embodiment, the present invention relates to compositions comprising PET. PCT, triclinic pinacoidal aluminium silicate and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, tris(nonylphenyl) phosphite, (2,4-di-tert-butylphenyl)-2-butyl-2-ethyl-1,3-propanediyl phosphite and tetrakis(2,4-di-tert-butylphenyl)-1,1-biphenyl-4,4′-diyl bisphosphonite. In a particularly preferred embodiment, the present invention relates to compositions comprising PET, PCT, triclinic pinacoidal aluminium silicate, talc and tetrakis(2,4-di-tert-butylphenyl)-1,1-biphenyl-4,4′-diyl bisphosphonite.

In a preferred embodiment, the present invention relates to compositions comprising PBT, PCT, triclinic pinacoidal aluminium silicate and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, tris(nonylphenyl) phosphite, (2,4,6-tri-t--butylphenol)-2-butyl-2-ethyl-1,3-propanediyl phosphite and tetrakis (2,4-di-tert-butylphenyl)-1-biphenyl-4,4′-diyl bisphosphonite. In a particularly preferred embodiment, the present invention relates to compositions comprising PBT, PCT, triclinic pinacoidal aluminium silicate, talc and tetrakis(2,4-di-tert-butylphenyl)-1,1 -biphenyl-4,4′-diyl bisphosphonite.

In a preferred embodiment, the present invention relates to compositions comprising PET, triclinic pinacoidal aluminium silicate, talc and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, tris(nonylphenyl) phosphite, (2,4,6-tri-t-butylphenol)-2-butyl-2-ethyl-1,3-propanediyl phosphite and tetrakis(2,4-di-tert-butylphenyl)-1,1-biphenyl-4,4′-diyl bisphosphonite. In a particularly preferred embodiment, the present invention relates to compositions comprising PET, triclinic pinacoidal aluminium silicate, talc and tetrakis(2,4-di-tert-butylphenyl)-1,1-biphenyl-4,4′-diyl bisphosphonite.

In a preferred embodiment, the present invention relates to compositions comprising PBT, triclinic pinacoidal aluminium silicate, talc and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, tris(nonylphenyl) phosphite, (2,4,-di-tert-butylphenyl)-2butyl-2-ethyl-1,3-propanediyl phosphite and tetrakis(2,4-di-tert-butylphenyl)-1,1 -biphenyl-4,4′-diyl bisphosphonite. In a particularly preferred embodiment, the present invention relates to compositions comprising PBT, triclinic pinacoidal aluminium silicate, talc and tetrakis(2,4-di-tert-butylphenyl)-1,1 -biphenyl-4,4′-diyl bisphosphonite.

In a preferred embodiment, the present invention relates to compositions comprising PCT, triclinic pinacoidal aluminium silicate, talc and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, tris(nonylphenyl) phosphite, (2,4,6-tri-t-butylphenol)-2-butyl-2-ethyl-1,3-propanediyl phosphite and tetrakis(2,4-di-tert-butylphenyl)-1,1-biphenyl-4,4′-diyl bisphosphonite. In a particularly preferred embodiment, the present invention relates to compositions comprising PCT, triclinic pinacoidal aluminium silicate, talc and tetrakis(tetrakis(2,4-di-tert-butylphenyl)-1,1 -biphenyl-4,4-diyl bisphosphonite.

In a preferred embodiment, the present invention relates to compositions comprising PET, PBT, triclinic pinacoidal aluminium silicate, talc and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, tris(nonylphenyl) phosphite, (2,4,6-tri-butylphenol)-2-butyl-2-ethyl-1,3-propanediyl phosphite and tetrakis(2,4-di-tert-butylphenyl)-1,1-biphenyl-4,4′-diyl bisphosphonite. In a particularly preferred embodiment, the present invention relates to compositions comprising PET, PBT, triclinic pinacoidal aluminium silicate, talc and tetrakis(2,4-di-tert-butylphenyl)-1,1-biphenyl-4,4′-diyl bisphosphonite.

In a preferred embodiment, the present invention relates to compositions comprising PET, PCT, triclinic pinacoidal aluminium silicate, talc and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, tris(nonylphenyl) phosphite, (2,4,6-tri-tert-butylphenol)-2-butyl-2-ethyl-1,3-propanediyl phosphite and tetrakis(2,4-di-tert-butylphenyl)-1,1-biphenyl-4,4′-diyl bisphosphonite. In a particularly preferred embodiment, the present invention relates to compositions comprising PET, PCT, triclinic pinacoidal aluminium silicate, talc and tetrakis(2,4-di-tert-butylphenyl)-1,1 -biphenyl-4,4′-diyl bisphosphonite.

In a preferred embodiment, the present invention relates to compositions comprising PBT, PCT, triclinic pinacoidal aluminium silicate, talc and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, tris(nonylphenyl) phosphite, (2,4,6-tri-tert-butylphenol)-2-butyl-2-ethyl-1,3-propanediyl phosphite and tetrakis(2,4-di-tert-butylphenyl)-1,1-biphenyl-4,4′-diyl bisphosphonite. In a particularly preferred embodiment, the present invention relates to compositions comprising PBT, PCT, triclinic pinacoidal aluminium silicate, talc and tetrakis(2,4-di-tert-butylphenyl)-1,1 -biphenyl-4,4′-diyl bisphosphonite.

In a preferred embodiment, the present invention relates to compositions comprising PET, PBT, PCT, triclinic pinacoidal aluminium silicate, talc and at least one phosphite stabilizer from the group of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4-dicumylphenyl)pentaerythrityl diphosphite, bis(nonylphenyl) phosphite, (2,4,6-tri-tert-butylphenol)-2-butyl-2-ethyl-1,3-propanediyl phosphite and tetrakis(2,4-di-tert-butylphenyl)-1,1 -biphenyl-4,4′-diyl bisphosphonite. In a particularly preferred embodiment, the present invention relates to compositions comprising PET, PBT, PCT, triclinic pinacoidal aluminium silicate, talc and tetrakis(2,4-di-tert-butylphenyl)-1,1 -biphenyl-4,4′-diyl bisphosphonite.

The present invention also relates to the use of triclinic pinacoidal aluminium silicate Al₂ SiO₅ for production of electrically insulating, thermally conductive products, preferably of heat sinks, especially of heat sinks for light-emitting diodes (LEDs).

The present invention also relates to the use of triclinic pinacoidal aluminium silicate Al₂SiO₅ in combination with talc for production of electrically insulating, thermally conductive products, preferably of heat sinks, especially of heat sinks for light-emitting diodes (LEDs).

The present invention also relates to the use of triclinic pinacoidal aluminium silicate Al₂SiO₅ for production of electrically insulating, thermally conductive polyester-based products, preferably of polyester-based heat sinks, especially of polyester-based heat sinks for light-emitting diodes (LEDs).

For this purpose, the inventive compositions in the form of moulding compositions are subjected to an injection moulding or extrusion operation in order to produce electrically insulating, thermally conductive products therefrom, preferably heat sinks, especially heat sinks for light-emitting diodes (LEDs), especially based on polyesters.

Moulding compositions for use in accordance with the invention for injection moulding or for extrusion are obtained by mixing the individual components of the inventive compositions, discharging them to form an extrudate, cooling the extrudate until it is pelletizable and palletizing it. Preference is given to mixing at temperatures in the range from 285 to 310° C. in the melt. Especially preferably, a twin-shaft extruder is used for this purpose. In a preferred embodiment, the pellets comprising the inventive composition are dried at 120° C. in a vacuum drying cabinet for about 2 h, before being subjected to the injection moulding operation or an extrusion process for the purpose of producing products.

The present invention also relates to a process for producing products, preferably electrically insulating, thermally conductive products, preferably heat sinks, especially heat sinks for light-emitting diodes (LEDs), by obtaining the matrix material as a moulding composition comprising the inventive compositions by injection moulding or extrusion, preferably by injection moulding.

The present invention also relates to a process for improving the thermal conductivity of polyester-based products, characterized in that inventive compositions in the form of moulding compositions are processed by injection moulding or extrusion.

The processes of injection moulding and extrusion of thermoplastic moulding compositions are known to those skilled in the art.

Inventive processes for producing products by extrusion or injection moulding work at melt temperatures in the range from 230 to 330° C., preferably from 250 to 300° C., and optionally additionally at pressures of not more than 2500 bar, preferably at pressures of not more than 2000 bar, more preferably at pressures of not more than 1500 bar and most preferably at pressures of not more than 750 bar.

Sequential coextrusion involves expelling two different materials successively in alternating sequence. In this way, a preform having a different material composition section by section in extrusion direction is formed. It is possible to provide particular article sections with specifically required properties through appropriate material selection, for example for articles with soft ends and a hard middle section or integrated soft bellows regions (Thielen, Hartwig, Gust, “Blasformen von Kunststoffhohlköpern” [Blow-Moulding of Hollow Plastics Bodies], Carl Hanser Verlag, Munich 2006, pages 127-129).

The process of injection moulding features melting (plasticization) of the raw material, preferably in pellet form, in a heated cylindrical cavity, and injection thereof as an injection moulding material under pressure into a temperature-controlled cavity. After the cooling (solidification) of the material, the injection moulding is demoulded.

The following stages are distinguished:
1. Plasticization/melting
2. Injection phase (filling operation)
3. Hold pressure phase (owing to thermal contraction in the course of crystallization)

4. Demoulding.

An injection moulding machine consists of a closure unit, the injection unit, the drive and the control system. The closure unit includes fixed and movable platens for the mould, an end platen, and tie bars and the drive for the movable mould platen (toggle joint or hydraulic closure unit).

An injection unit comprises the electrically heatable barrel, the drive for the screw (motor, gearbox) and the hydraulics for moving the screw and the injection unit. The task of the injection unit is to melt the powder or the pellets, to meter them to inject them and to maintain the hold pressure (owing to contraction). The problem of the melt flowing backward within the screw (leakage flow) is solved by non-return valves.

In the injection mould, the incoming melt is then separated and cooled, and hence the product to be produced is produced. Two halves of the mould are always needed for this purpose. In injection moulding, the following functional systems are distinguished:
runner system
shaping inserts
venting
machine casing and force absorber
demoulding system and movement transmission
temperature control

In contrast to injection moulding, extrusion uses a continuous shaped polymer strand in the extruder, the extruder being a machine for producing shaped thermoplastics. The following stages are distinguished:
single-screw extruder and twin-screw extruder and the respective sub-groups
conventional single-screw extruder, conveying single-screw extruder,
contra-rotating twin-screw extruder and co-rotating twin-screw extruder.

Extrusion systems consist of extruder, mould, downstream equipment, extrusion blow moulds. Extrusion systems for production of profiles consist of: extruder, profile mould, calibration, cooling zone, caterpillar take-off and roll take-off, separating device and tilting chute.

The present invention consequently also relates to products, especially to thermally conductive products, obtainable by extrusion, profile extrusion or injection moulding of the inventive compositions.

The present invention also relates to mixtures of talc and triclinic pinacoidal aluminium silicate (CAS No. 1302-76-7).

The present invention preferably relates to a process for producing products, preferably thermally conductive products, characterized in that the abovementioned compositions, preferably compositions comprising
a) 15% to 70% by weight, preferably 15% to 50% by weight, more preferably 20% to 40% by weight of at least one polyester, preferably PBT, PET or PCT or blends of any desired combinations thereof, more preferably blends of PBT and PET in which the proportion of PET based on the sum total of all the polyesters present is in the range from 50% to 99.9% by weight, and
b) 30% to 85% by weight of aluminium silicate, preferably 45% to 80% by weight of aluminium silicate, more preferably 55% to 75% by weight of aluminium silicate, where the sum total of all weight percentages is 100, are processed to give moulding compositions, preferably by means of at least one mixing or kneading apparatus, and these are subjected to an injection moulding or extrusion operation.

The products produced in the inventive manner are outstandingly suitable for production of electrically insulating, thermally conductive products, preferably of heat sinks, especially of heat sinks for light-emitting diodes (LEDs).

### EXAMPLES

Reactants: PBT: Pocan® B1300 polybutylene terephthalate from Lanxess Deutschland GmbH, Cologne, Germany

PET: PET V004 polyester chips from Invista, Wichita, USA

Phosphite stabilizer: Hostanox® P-EPQ from Clariant International Ltd., Muttenz, Switzerland

Talc: Mistron® R10 from Imerys Talc Group, Toulouse, France (Rio Tinto Group)

Demoulding agent: Licowax® E from Clariant international Ltd., Muttenz, Switzerland

Kyanite (CAS No. 1302-76-7); Silatherm® Al₂SiO₅ particles with epoxysilane slip coating, Quarzwerke GmbH, Frechen, Germany.

Mullite (CAS No. 1302-93-8): MJ5M mullite, Kyanite Mining Corp., Dillwyn, Va., USA

Alumina: Martoxid® MDS from Albemarle Corp. Baton Rouge, Louisiana, USA

Boron nitride: Boronid TCP015FK from ESK, Kemplen, Germany

### Experimental Procedure:

To produce the compositions described in accordance with the invention, the individual components were mixed in a twin-shaft extruder (ZSK 26 Mega Compounder from Coperion Werner & Pfleiderer (Stuttgart, Germany with 3-hole die plate and a die hole diameter of 3 mm) at temperatures between 280 and 295° C. in the melt and discharged as an extrudate, and the extrudate was cooled until pelletizable and pelletized. Before the further steps, the pelletized material was dried at 120° C. in a vacuum drying cabinet for about 2 h.

The sheets and test specimens for studies conducted in Table 1 and Table 2 were injection-moulded on a conventional injection moulding machine at a melt temperature of 280-290° C. and a mould temperature of 80-120° C.

### Measurement of Impact Resistance:

The impact resistance [kJ/m²] of the products produced from the inventive thermoplastic moulding compositions was determined in an impact test to ISO 180-1U at 23° C.

### Measurement of Edge Fibre Elongation:

The edge fibre elongation [%] of the products produced from the inventive thermoplastic moulding compositions was determined in a bending test to ISO 178-A at 23° C.

### Measurement of Thermal Conductivity:

Thermal conductivity [kJ/m²] was determined on sheets having the dimensions 12.7 mm-12.7 mm-2 mm to ISO 22007-4.

TABLE 1

| | Ex. 1 | Comp. 1 | Comp. 2 |
|---|---|---|---|
| PBT | 49.5 | 49.5 | 49.5 |
| Aluminium silicate | 50 | | |
| Alumina | | 50 | |
| Boron nitride | | | 50 |
| Demoulding agent | 0.3 | 0.3 | 0.3 |
| Phosphite stabilizer | 0.1 | 0.1 | 0.1 |
| Talc | 0.1 | 0.1 | 0.1 |
| Impact resistance | 36 | 0 | 27 |
| Edge fibre | 3.4 | 1.0 | 3.0 |
| elongation | | | |

As apparent from Table 1 (Ex.=inventive example; Comp.=comparative example according to the prior art), much better mechanical properties are obtained for products based on the inventive compositions using aluminium silicate with the same filler level, especially compared to boron nitride. For a comparison of thermal conductivities at higher filler levels, therefore, inventive products were compared with products containing only alumina (Table 2).

TABLE 2

| | Ex. 2 | Comp. 3 | Comp. 4 |
|---|---|---|---|
| PBT | 34.5 | 34.5 | 34.5 |
| Kyanite | 65 | | |
| Alumina | | 65 | |
| Mullite | | | 65 |
| Impact resistance | 0.3 | 0.3 | 0.3 |
| [w/mK] | | | |
| Phosphite stabilizer | 0.1 | 0.1 | 0.1 |
| Talc | 0.1 | 0.1 | 0.1 |
| Impact resistance | 18 | 10 | 9 |
| [w/mK] | | | |
| Thermal | 1.0 | 0.7 | 0.8 |
| conductivity [kJ/m²] | | | |

Comparison of Ex. 2 and Comp. 3 shows that both better thermal conductivities and better impact resistances can be obtained in the case of specimens obtainable from moulding compositions of inventive compositions compared to specimens formed from moulding compositions comprising compositions comprising alumina. Comparison of Ex. 2 and Comp. 4 shows that both better thermal conductivities and better impact resistances can be obtained in the case of specimens obtainable from moulding compositions of inventive compositions compared to specimens formed from moulding compositions composing compositions comprising aluminium silicates not having a triclinic pinacoidal crystal structure. The mullite used in Comp. 4 is an aluminium silicate having orthorhombic dipyramidal crystal structure.

1. A composition comprising
a) 15% to 70% by weight of at least one polyester,
b) 29% to 84% by weight of aluminium silicate, and optionally
c) 0.01 % to 15% by weight of talc,
wherein the composition is one of (a+b) or (a+b+c) and the sum total of all the percentages by weight is always 100%,

2. The composition according to claim 1, further optionally comprising
d) 0.01 % to 5% by weight of at least one phosphite stabilizer,
wherein the composition is one of (a+b), (a+b+c), (a+b+d) or (a+b+c+d) and the sum total of all the percentages by weight is always 100%.

3. The composition according to claim 2, further optionally comprising
e) 0.01% to 10% by weight of at least one additive for improving flowability,
wherein the composition is one of (a+b), (a+b+c), (a+b+d), (+b+e), )a+b+c+d), (a+b+c+e), (a+b+d+e), or (a+b+c+d+e) and the sum total of all the percentages by weight is always 100.

4. The composition according to claim 3, further optionally comprising
f) 0.01% to 5% by weight of at least one form of carbon black,
wherein the composition is one of (a+b), (a+b+c), (a+b+c+f), (a+b++d+f), (a+b+c+d), (a+b+c+e), (a+b+d+e), (a+b+c+f), (a+b+d+f), (a+b+e+f), (a+b+c+d+e), (a+b+c+d+f), (a+b+c+f), (a+b+d+e+f), or (a+b+c+d+e+f) and the sum total of all the percentages by weight is always 100%.

5. The composition according to claim 4, further optionally comprising
g) 0.01 % to 15% by weight of at least one demoulding agent,
wherein the composition is one of (a+b), (a+b+c), (a+b+d), (a+b+e), (a+b+f), (a+b+g), (a+b+c+d), (a+b+c+e), (a+b+d+e), (a+b+c+f), (a+b+d+f), (a+b+e+f), (a+b+c+g), (a+b+d+g), (a+b+e+g), (a+b+f+q), (a+b+c+d+e), (a+b+c+d+f), (a+b+c+e+f), (a+b+d+e+f), (a+b+c+d+g) (a+b+c+e+g), (a+b+d+e+g), (a+b+c+f+g), (a+b++d+f+g), (a+b+e+f+g), (+a+b+c+d+e+f), (a+b+c+d+e+g), (a+b+c+d+f+g), (a+b+c+e+f+g), (a+b+d+e+f+g), or (a+b+c+d+f+g) and the sum total of ail the percentages by weight is always 100%.

6. The composition according to claim 5, further optionally comprising
h) 0.01 % to 45% by weight of at least one other additive other than components c) to g),
wherein the composition is one of (a+b), (a+b+c), (a+b+e), (a+b+f), (a+b+g), (a+b+h), (a+b+c+d), (a+b+c+e), (a+b+d+e), (a+b+c+f), (a+b+d+f), (a+b+e+f), (a+b+c+g), (a+b+d+g), (a+b+e+g), (a+b+f+g), (a+b+c+h), (a+b+d+h), (a+b+e+h), (a+b+f+h), (a+b+g+h), (a+b+c+d+e), (a+b+c+d+f), (a+b+c+e+f), (a+b+d+e+f), (a+b+c+d+g), (a+b+c+e+g), (a+b+d+e+g), (a+b+c+f+g), (a+b+d+f+g), (a+b+e+f+g), (a+b+c+d+h), (a+b+b+c+e+h), (a+b+d+e+h), (a+b+c+f+h), (a+b+d+f+h), (a+b+e+f+h), (a+b+c+g+h), (a+b+d+g+h), (a+b+e+g+h), (a+b+f+g+h), (a+b+c+d+e+f), (a+b+c+d+e+g), (a+b+c+d+f+g), (a+b+c+e+f+g), (a+b+d+e+f+g), (a+b+c+d+e+h), (a+b+c+d+f+h), (a+b+c+e+f+h), (a+b+d+e+f+h), (a+b+c+d+g+h), (a+b+c+e+g+h), (a+b+d+e+g+h), (a+b+c+f+g+h), (a+b+d+f+g+h), (a+b+e+f+g+h), (a+b+c+c+d+e+f+g), (a+b+c+d+e+f+h), (a+b+e+f+g+h), (a+b+c+d+f+g+h), (a+b+c+e+f+g+h), (a+b+d+e+f+g+h), or (a+b+c+d+e+f+g+h) and the sum total of all the percentages by weight is always 100.

7. The composition according to claim 6, wherein at least one other additive comprises glass fibres.

8. The composition according to claim 2, wherein the at least one phosphite stabilizer is at least one selected from the group consisting of tris(2,4-di-tert-butylphenyl) phosphite, bis(2,4-di-tert-butylphenyl)pentaerythrityl diphosphite, bis(2,6-di-tert-butyl-4-methylphenyl)pentaerythrityl diphosphite, bis(2,4dicumylphenyl)pentaerythrityl diphosphite, tris(nonylphenyl)phosphite, (2,4,6-tri-t-butylphenol)-2-butyl-2-ethyl-1,3-propanediol phosphite and tetrakis(2,4-di-tert-butylphenyl)-11,-biphenyl-4,4′-diyl bisphosphonite..

9. The composition according to claim 1, wherein the aluminium silicate is triclinic pinacoidal aluminium silicate Al₂SiO₅.

10. The composition according to claim 1, wherein the at least one polyester is at least one polyalkylene terephthalate or polycycloalkylene terephthalate.

11. The composition according to claim 1, wherein the at least one polyester is at least one polyester selected from the group consisting of polybutylene terephthalate (PBT), polyethylene terephthalate (PET), poly(1,4-cyclohexanedimethanol terephthalate) (PCT), or a blend based on PBT and PET, or a blend based on PBT and PCT, or a blend based on PET and PCT, or a blend based on PBT, PET and PCT.

12. A method for producing, thermally conductive products, the method comprising producing thermally conductive products from a composition comprising triclinic pinacoidal aluminium silicate.

13. The method according to claim 12, wherein the composition comprises aluminium silicate in combination with talc.

14. The method according to claim 12, wherein the thermally conductive products comprise polyester based products and the method comprises producing the thermally conductive products from a composition comprising polyester and the triclinic pinacoidal aluminium silicate.

15. A process for producing products, the process comprising processing a composition according to claim 1 to give moulding compositions and injection moulding or extruding the moulding compositions to form the products.

16. The composition according to claim 1, further optionally comprising
e) 0.01% to 10% by weight of at least one additive for improving flowability,
wherein the composition is one of (a+b), (a+b+c), (a+b+e) or (a+b+c+e) and the sum total of all the percentages by weight is always 100%.

17. The composition according to claim 1, further optionally comprising
f) 0.01 % to 5% by weight of at feast one form of carbon black,
wherein the composition is one of (a+b) (a+b+c), (a+b+f) or (a+b+c+f) and the sum total of all the percentages by weight is always 100%.

18. The composition according to claim 1, further optionally comprising
g) 0.01% to 15% by weight of at least one demoulding agent,
wherein the composition is one of (a+b), (a+b+c), (a+b+g) or (a+b+c+g) and the sum total of all the percentages by weight is always 100%.

19. The composition according to claim 1, further optionally comprising
h) 0.01 % to 45% by weight of glass fibres,
wherein the composition is one of (a+b), (a+b+c), (a+b+h) or (a+b+c+h) and the sum total of all the percentages by weight is always 100%.
